(19) United States
(12) Patent Application Publication
(10) Pub. No.: US 2019/0118534 A1
(43) Pub. Date: Apr. 25, 2019

(54) FLUID EJECTION HEAD AND FLUID EJECTION APPARATUS

(71) Applicant: TOSHIBA TEC KABUSHIKI KAISHA, Tokyo (JP)

(72) Inventor: Isao SUZUKI, Mishima Shizuoka (JP)

(21) Appl. No.: 16/144,137

(22) Filed: Sep. 27, 2018

(30) Foreign Application Priority Data
Oct. 24, 2017 (JP) 2017-205250
Jul. 20, 2018 (JP) 2018-136653

(51) Int. Cl. B41J 2/14

(52) U.S. Cl. CPC B41J 2/14209; B41J 2/1433; B41J 2002/14225; B41J 2202/12; B41J 2/14048

(57) ABSTRACT

A fluid ejection head includes a pressure chamber and a nozzle plate including a nozzle group. The nozzle plate has a discharge face with an upstream side and a downstream side. The nozzle group is in fluid communication with the pressure chamber and includes a first nozzle on the upstream side of the discharge face, a second nozzle on the downstream side of the discharge face, and a third nozzle between the first and second nozzles. Central axes of the first and second nozzles are inclined with respect to a central axis of the third nozzle such that the central axes of the first and second nozzles intersect the central axis of the third nozzle. A flow channel dimension of the third nozzle is different from flow channel dimensions of the first and second nozzles.

### CROSS-REFERENCE TO RELATED APPLICATION

This application is based upon and claims the benefit of priority from Japanese Patent Applications Nos. 2017-205250, filed Oct. 24, 2017 and 2018-136653, filed Jul. 20, 2018, the entire contents of which are incorporated herein by reference.

### FIELD

Embodiments described herein relate generally to a fluid ejection head and a fluid ejection apparatus.

### BACKGROUND

A fluid ejection head, such as an ink jet head, may include a nozzle plate having a plurality of nozzles formed therein, a plurality of pressure chambers facing the nozzle plate and in fluid communication with the nozzles, and a base plate forming a common chamber in fluid communication with the pressure chambers. A voltage is applied to a drive element provided in the pressure chamber to generate a pressure variation and thereby eject fluid from the nozzle. A fluid holding tank is connected to the fluid ejection head, and the fluid is circulated in a circulation path passing through the fluid ejection head and the fluid holding tank.

In such fluid ejection heads, there is a known configuration in which several nozzles communicate with one pressure chamber. For example, if three or more nozzles of the same shape are aligned, an ejection speed of the fluid from the nozzle located at the center will be slowed down. Accordingly, if the fluid is ejected towards an ejection target that moves relative to the fluid ejection head, ejected droplets may hit the ejection target at slightly different locations or ejected droplets may be elongated differently in a particular direction paralleling to the target movement direction.

### DESCRIPTION OF THE DRAWINGS

FIG. 1 is an explanatory diagram of a fluid ejection apparatus according to a first embodiment.

FIG. 2 is a perspective view of a fluid ejection head of a fluid ejection apparatus.

FIG. 3 is an exploded perspective view of a fluid ejection head.

FIG. 4 is a cross-sectional view of a fluid ejection head.

FIG. 5 is an exploded cross-sectional view of a fluid ejection head.

FIG. 6 is an exploded cross-sectional view of a fluid ejection head.

FIG. 7 is an explanatory diagram of a nozzle of a fluid ejection head.

FIG. 8 is an explanatory diagram of a nozzle and a landing state.

FIG. 9 is an explanatory diagram of a nozzle and a landing state.

FIG. 10 is a cross-sectional view of a nozzle plate of a fluid ejection head according to another embodiment.

FIG. 11 is a cross-sectional view of a nozzle plate.

FIG. 12 is a bottom view of a nozzle plate.

FIG. 13 is a cross-sectional view of a nozzle plate.

### DETAILED DESCRIPTION

In general, according to one embodiment, a fluid ejection head includes a pressure chamber and a nozzle plate including a nozzle group. The nozzle plate has a discharge face with an upstream side and a downstream side. The nozzle group is in fluid communication with the pressure chamber and includes a first nozzle on the upstream side of the discharge face, a second nozzle on the downstream side of the discharge face, and a third nozzle between the first and second nozzles. Central axes of the first and second nozzles are inclined with respect to a central axis of the third nozzle such that the central axes of the first and second nozzles intersect the central axis of the third nozzle. A flow channel dimension (such as minimum opening dimension, taper rate, and/or throttle dimension) of the third nozzle is different than corresponding flow channel dimensions of the first and second nozzles.

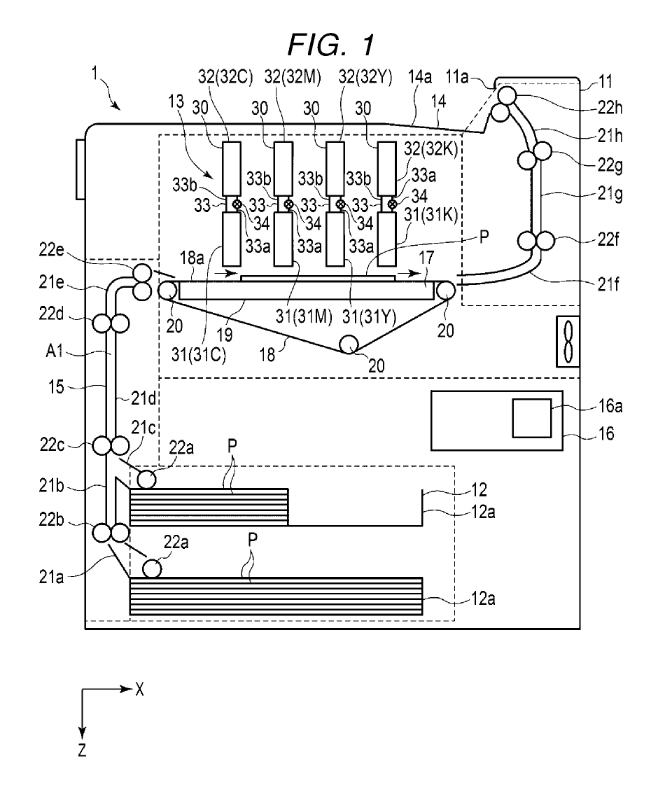

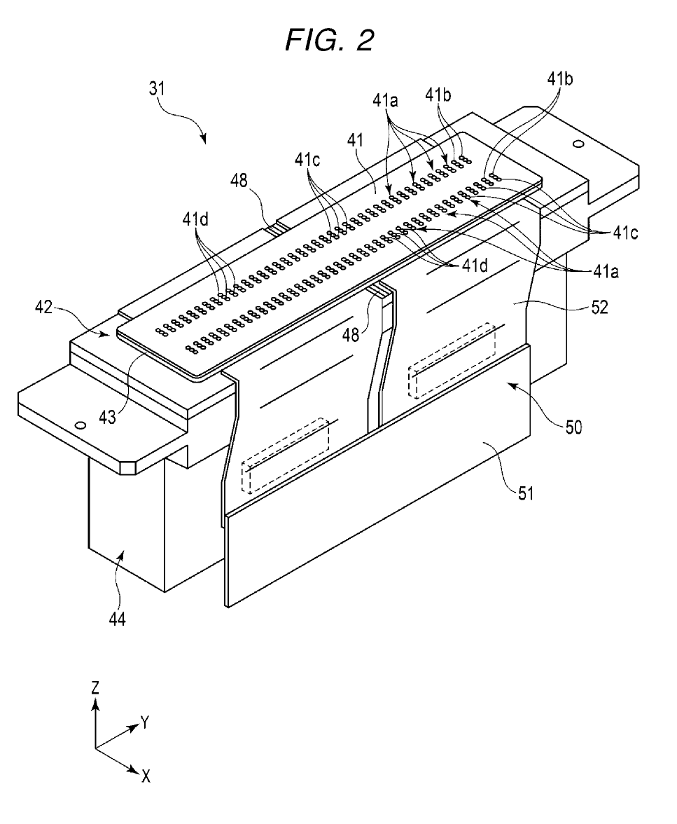

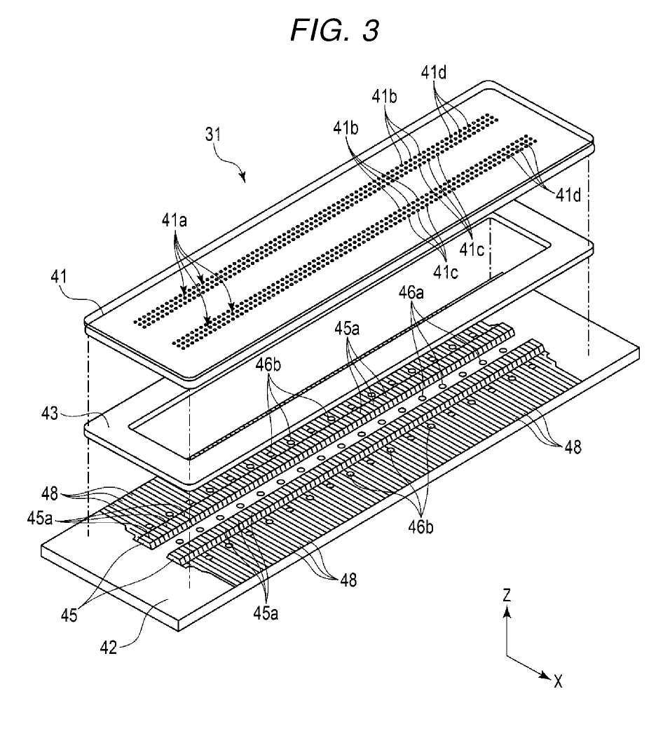

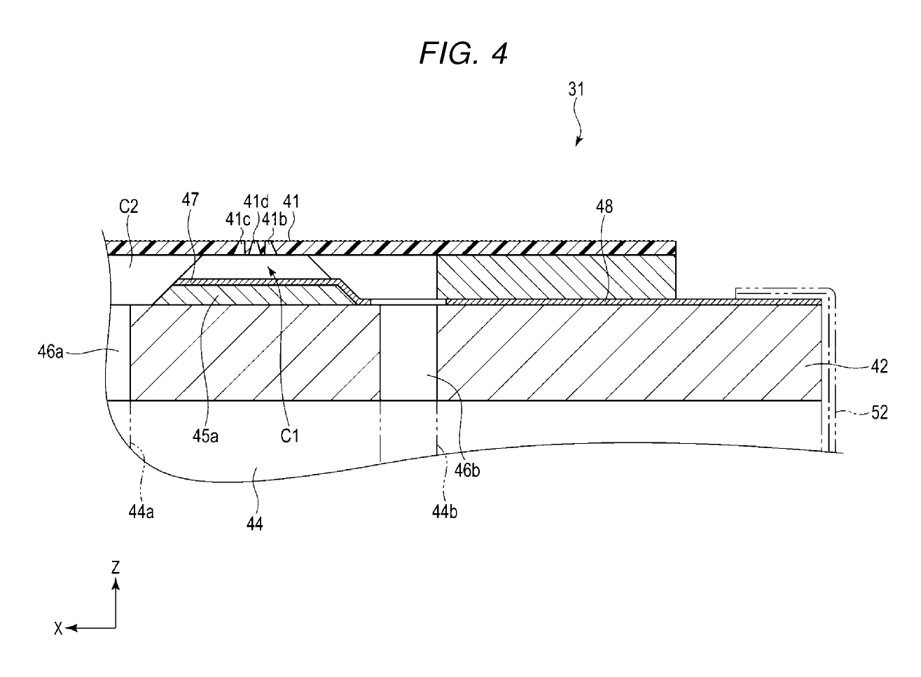

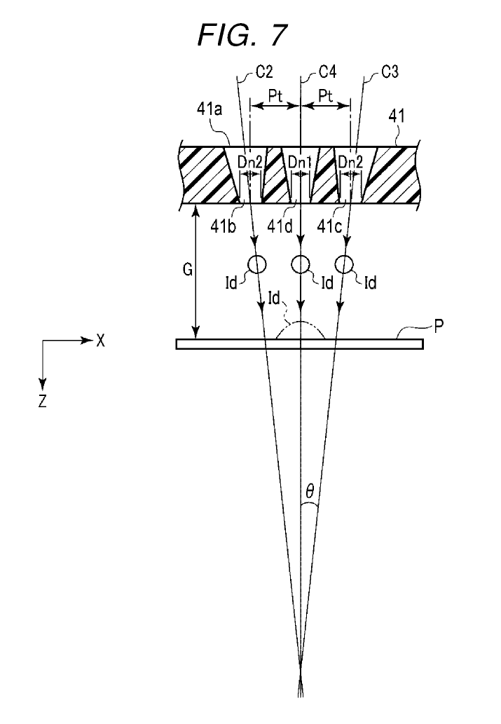

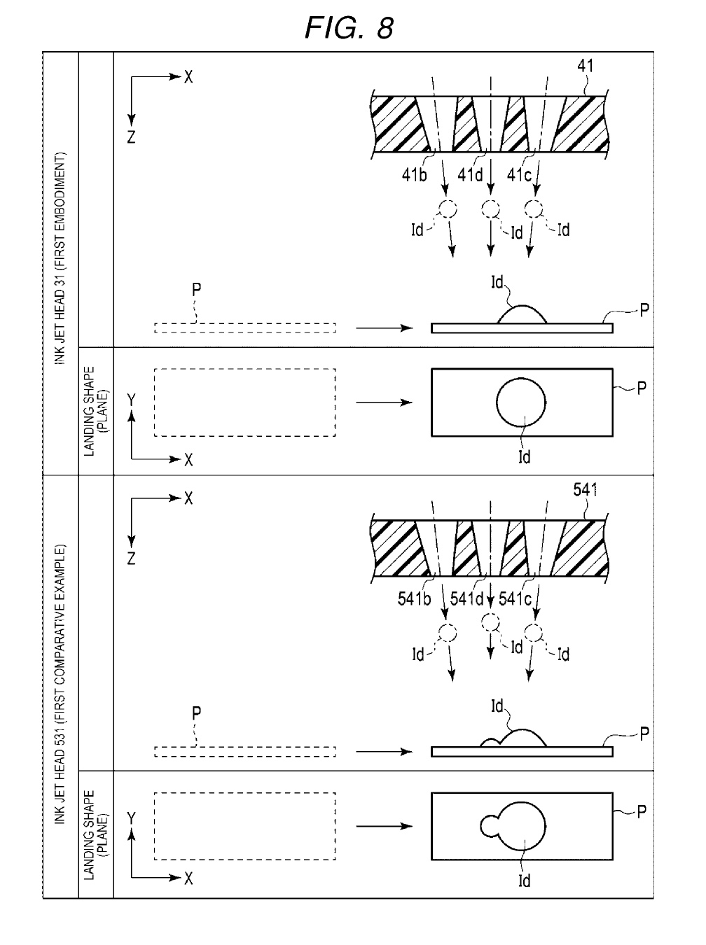

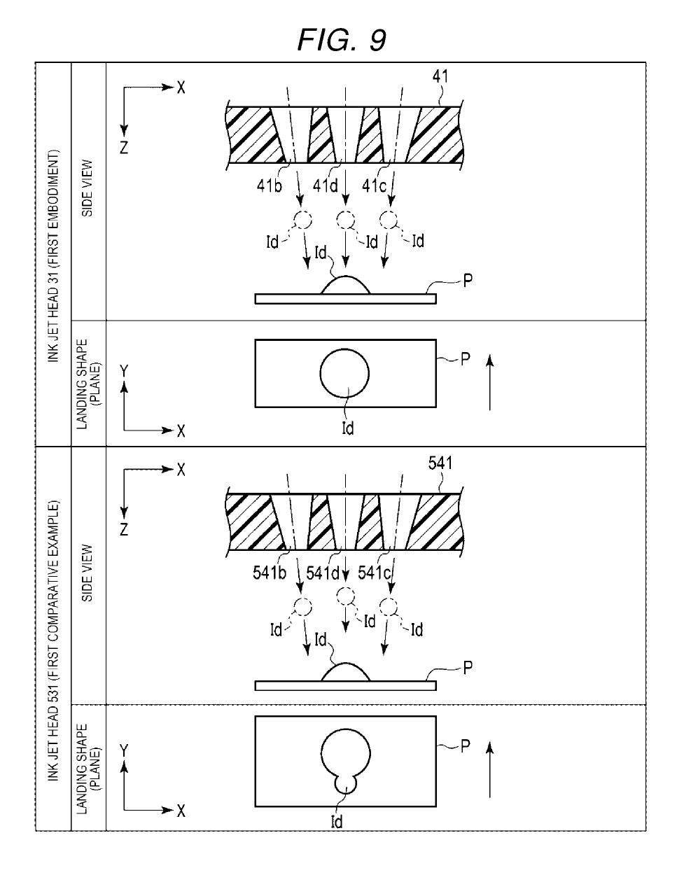

Hereinafter, an ink jet recording apparatus 1, as an example of a fluid ejection apparatus, according to a first embodiment and an ink jet head 31 as an example of a fluid ejection head, will be described with reference to FIGS. 1 to 9. FIG. 1 is a diagram of an ink jet recording apparatus 1. FIG. 2 is a perspective view of the ink jet head 31. FIG. 3 is an exploded perspective view of the ink jet head 31. FIGS. 4 to 6 are cross-sectional views of the ink jet head 31. FIG. 7 is an explanatory diagram of a nozzle of the ink jet head 31. FIGS. 8 and 9 are explanatory diagrams of the nozzles of the ink jet head 31 and the state of a landing state. The labels X, Y, and Z in the figures indicate three directions orthogonal to each other. In the example embodiments depicted in the figures, the Z direction is made with reference to a device posture in which nozzles 41b, 41c, and 41d of the ink jet head 31 are disposed to eject fluids in a downward Z direction, but the present disclosure is not limited thereto and the inclusion of the reference axis X, Y, and Z in the figures and description is for explanatory convenience.

As illustrated in FIG. 1, the ink jet recording apparatus 1 includes a housing 11, a medium supply unit 12, an image forming unit 13, a medium discharge unit 14, a transport apparatus 15, and a control unit 16.

The ink jet recording apparatus 1 is a fluid ejection apparatus that forms an image on paper P by ejecting fluid, such as an ink, onto the paper P while transporting the paper P along a transport path A1. The transport path A1 extends from the medium supply unit 12 to the medium discharge unit 14 and passes through the image forming unit 13.

The housing 11 forms an exterior of the ink jet recording apparatus 1. A discharge hole 11a for discharging the paper P to the outside is provided on the housing 11.

The medium supply unit 12 includes a plurality of paper feeding cassettes 12a in the housing 11. The paper feeding cassettes 12a are each formed in, for example, a box-like shape of a predetermined size having an opening on an upper side and are configured to be able to stack and hold a plurality of sheets of paper P of various sizes.

The medium discharge unit 14 includes a paper discharge tray 14a near the discharge hole 11a of the housing 11. The paper discharge tray 14a is configured to hold the paper P discharged from the discharge hole 11a.

The image forming unit 13 includes a support unit 17 that supports the paper P, and a plurality of head units 30 above the support unit 17.

The support unit 17 includes a transport belt 18 in a loop shape in a region where an image is formed on the paper P, a support plate 19 for supporting the transport belt 18 from a back side, and a plurality of belt rollers 20 provided on the back side of the transport belt 18.

The support unit 17 supports the paper P on a holding surface 18a, which is an upper surface of the transport belt 18, during the image formation process and moves the transport belt 18 at a predetermined speed by rotation of the belt roller 20, and thereby, the paper P is transported through the image forming unit 13 to a downstream side.

The head unit 30 comprises a plurality of ink jet heads 31 for four colors (CMYK), ink tanks 32, as fluid holding tanks, respectively mounted on the ink jet heads 31, a connection flow path 33 connecting the ink jet head 31 to the respective ink tank 32, and a circulation pump 34 that is a circulation unit. The head unit 30 is a circulation type head unit that continuously circulates fluid from the ink tank 32 to a pressure chamber C1 and a common chamber C2 (see FIG. 4) in the ink jet head 31.

In the example embodiments described herein, the ink jet heads 31C, 31M, 31Y, and 31K for four colors, cyan, magenta, yellow, and black, are provided. Ink tanks 32C, 32M, 31Y, and 31K are provided for these colors. Each ink tank 32 is connected to an ink jet head 31 through a connection flow path 33. The connection flow path 33 includes a supply flow path 33a connected to a supply hole of the ink jet head 31 and a recovery flow path 33b connected to the discharge hole of the ink jet head 31.

In addition, the ink tanks 32 are connected to a negative pressure control apparatus such as a pump (not specifically depicted in the drawings). When the negative pressure control apparatus applies a negative pressure to an ink tank 32 in response to liquid levels in the ink jet head 31 and the ink tank 32, the ink at each of nozzles 41b, 41c, and 41d of the ink jet head 31 is formed into a meniscus of a predetermined shape.

The circulation pump 34 is a fluid displacement pump configured from, for example, a piezoelectric pump. The circulation pump 34 is connected to the supply flow path 33a. The circulation pump 34 is connected to a drive circuit of the control unit 16 by wiring, such that the circulation pump 34 can be controlled by a central processing unit (CPU) 16a. The circulation pump 34 circulates the fluid in the circulation flow path including the ink jet head 31 and the ink tank 32.

The transport apparatus 15 transports the paper P along the transport path A1 through the image forming unit 13 from the paper feeding cassette 12a to the paper discharge tray 14a. The transport apparatus 15 includes guide plate pairs 21a to 21h disposed along the transport path A1 and a plurality of transport rollers 22a to 22h.

Each of the guide plate pairs 21a to 21h includes a pair of plates disposed so as to face each other with the transported paper P being transported therebetween to guide the paper P along the transport path A1.

The transport rollers 22a to 22h include a paper feeding roller 22a, multiple pairs of transport rollers 22b to 22g, and a pair of discharge rollers 22h. The transport rollers 22a to 22h rotate by being driven under the control of the CPU 16a of the control unit 16 to send the paper P to a downstream side along the transport path A1. Sensors for detecting the transport status of the paper are disposed in various places in the transport path A1.

The control unit 16 includes the CPU 16a which is a controller, a read only memory (ROM) for storing various programs and the like, a random access memory (RAM) for temporarily storing various variable data, image data, and the like, and an interface unit for inputting data from the outside and outputting data to the outside.

As illustrated in FIGS. 2 to 5, the ink jet head 31 includes a nozzle plate 41, a base plate 42, a frame 43, and a manifold 44.

The nozzle plate 41 is formed in a rectangular plate shape. The nozzle plate 41 includes a plurality of nozzle groups 41a, each of which includes a nozzle 41b, a nozzle 41c, and a nozzle 41d communicating with a pressure chamber C1.

In the example embodiments described herein, nozzle groups 41a, each including three nozzles, are formed in parallel for each row of the pressure chambers C1, which are disposed in two parallel rows. Each of the nozzle groups 41a includes nozzles 41b, 41c, and 41d that communicate with one pressure chamber C1. In each of the nozzle groups 41a, the three nozzles 41b, 41c, and 41d are provided in parallel in the X direction.

As illustrated in FIGS. 6 and 7, the nozzles 41b, 41c, and 41d each have a truncated cone shape of a tapered shape in which a nozzle diameter on an ejection surface side (also referred to as a fluid ejection side) is reduced. The nozzle 41d disposed at a central portion of the nozzle group 41a has a central axis C4 extending perpendicularly to the ejection surface. The centers C2 and C3 of the nozzles 41b and 41c disposed at the end of the nozzle group 41a are inclined with respect to the central axis C4 such that the discharge hole sides approach each other.

Here, when a distance between the nozzles 41b, 41c, and 41d is referred to as a nozzle pitch or a pitch Pt, a distance between the nozzles 41b, 41c, and 41d and the paper P is referred to as G, and an axis angle between an axis of the nozzle at the end and the central axis of the nozzle 41d at the center of the nozzle group 41a is referred to as θ, the relationship

2×Pt/G>tan θ>0 (Equation 1)

will hold. That is, a distance between droplets Id as-landed on the paper P is smaller than the pitch Pt between the nozzles 41b, 41c, and 41d.

In the nozzle group 41a of nozzles 41b, 41c, and 41d disposed to face a common pressure chamber C1, a shape of the nozzle 41d (at the center of the nozzle group 41a) is different from shapes of the nozzles 41b and 41c (which are disposed at either end of the nozzle group 41a), such that an ejection speed of the fluid is adjusted. That is, among the three or more nozzles 41b, 41c, and 41d that are aligned in parallel, the nozzle 41d at the center has a smaller diameter (also referred to as a throttling dimension) than the nozzles 41b and 41c at either of the end portions along the parallel direction such that the ejection speed is uniform among the three or more nozzles. In other words, the nozzle 41d, which is located at a position more distant from a supply path 44a or a recovery path 44b than the nozzles 41b, 41c, is formed to have a smaller diameter than the nozzles 41b and 41c located closer to the supply path 44a or the recovery path 44b.

Specifically, an area of the opening of the nozzle 41d is formed to be smaller than an area of the openings of the nozzles 41b and 41c. That is, a nozzle diameter Dn1 on the ejection surface side (that is the minimum diameter (throttling dimension) of the nozzle 41d of a generally cylindrical shape) is configured to be smaller than a nozzle diameter Dn2 on the ejection surface side (that is the minimum diameter (throttling dimension) of the nozzles 41b and 41c). For example, the diameter of the nozzle 41d is 27 μm and the diameters of the nozzles 41b and 41c are 30 μm. In this example, a ratio between the diameters of nozzles in the nozzle group 41a is the diameter of nozzle at the central portion to the diameter of nozzle at the ends, that is, 9:10.

The base plate 42 is formed in a rectangular shape, and is bonded to face the nozzle plate 41 with the frame 43 interposed therebetween. A common chamber C2 is formed between the base plate 42 and the nozzle plate 41.

A piezoelectric block 45 including a plurality of piezoelectric elements 45a which acts as drive elements is provided on a surface of the base plate 42 facing the nozzle plate 41. The piezoelectric block 45 has an elongated shape in which a longitudinal direction extends in the first direction, and includes a plurality of piezoelectric elements 45a in parallel in the second direction. In the second direction, a groove for forming the pressure chamber C1 is formed between adjacent piezoelectric elements 45a. The piezoelectric element 45a is formed of a piezoelectric ceramic material such as lead zirconate titanate (PZT). Electrode 47 are formed on both end surfaces of the piezoelectric elements 45a in the parallel direction. The electrodes 47 are electrically connected to a circuit board 50 via a wiring pattern 48.

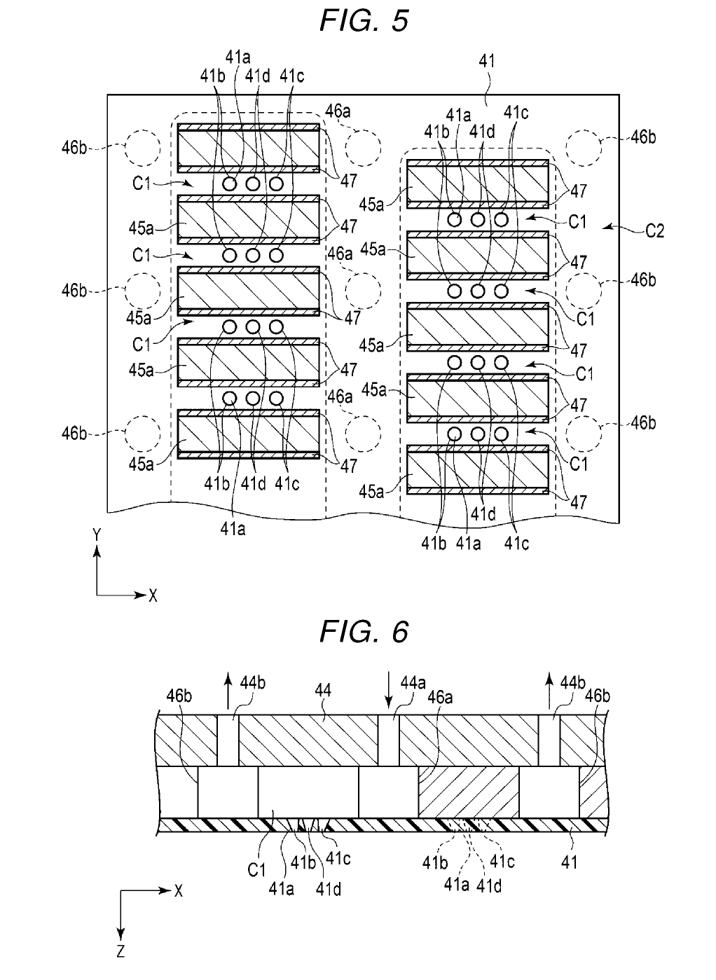

In the pair of piezoelectric blocks 45, positions of the respective piezoelectric elements 45a are shifted in the second direction by one-half of the arrangement pitch of the piezoelectric elements 45a. That is, as illustrated in FIG. 5, the pressure chambers C1, formed in two rows, is at a position shifted by one-half of the distance from the pressure chambers C1 in the second direction. Accordingly, the droplet Id is landed on the paper P at an interval that is half the pitch of the pressure chamber C1.

The base plate 42 has a supply hole 46a and a recovery hole 46b. The supply hole 46a is a through-hole penetrating the base plate 42 in a thickness direction, and communicates with the supply path 44a of the manifold 44. The recovery hole 46b is a through-hole penetrating the base plate 42 in the thickness direction, and communicates with the recovery path 44b of the manifold 44. That is, the supply hole 46a and the recovery hole 46b are connected to an external side of the nozzle group 41a in the first direction that is a juxtaposed direction in which the nozzles 41b, 41c, and 41d are disposed.

The frame 43 is formed in a rectangular frame shape and is disposed between the base plate 42 and the nozzle plate 41. The frame 43 has a predetermined thickness and forms the common chamber C2 between the base plate 42 and the nozzle plate 41.

The manifold 44 is a rectangular block shape and is bonded to the base plate 42. The manifold 44 has ink flow channels that communicate with the common chamber C2. Each ink flow channel includes supply path 44a and the recovery path 44b. The supply path 44a is fluidly connected to the supply flow path 33a, and the recovery path 44b is fluidly connected to the recovery flow path 33b. The circuit board 50 is provided on the outer surface of the manifold 44. The circuit board 50 has a drive IC 51 mounted thereon. The drive IC 51 is electrically connected to the electrode 47 of the piezoelectric element 45a via flexible printed circuits (FPC) 52 and the wiring pattern 48.

When the nozzle plate 41, the base plate 42, the frame 43, and the manifold 44 are assembled together as described, the ink jet head 31 is formed and provides a plurality of pressure chambers C1 therein and ink flow channels connecting these pressure chambers. The pressure chambers C1 are separated from one another by the piezoelectric elements 45a serving as dividing walls.

An operation of the ink jet recording apparatus 1 configured as described above will be described below. The CPU 16a detects a print instruction made by an operation of a user form input unit, for example, via an interface. Then, if the print instruction is detected, the CPU 16a controls the transport apparatus 15 to transport the paper P and outputs a print signal to the head unit 30 at a predetermined timing to drive the ink jet head 31. Based on an image signal corresponding to image data, the piezoelectric elements 45a are selectively drive such that ink is discharged from the nozzles 41b, 41c, and 41d adjacent to each piezoelectric element 45a, and thereby an image is formed on the paper P held on the transport belt 18.

During a fluid ejection operation, the CPU 16a controls the drive circuit to apply a drive voltage to the electrode 47 on the piezoelectric element 45a via the wiring pattern 48 to deform the piezoelectric elements 45. For example, when the piezoelectric element 45a is driven so as to increase the volume of the pressure chamber C1 and create a negative pressure in the pressure chamber C1, ink is guided back into the pressure chamber C1. When the piezoelectric element 45a is driven as to decrease the volume of the pressure chamber C1 and apply pressure to the inside of the pressure chamber C1, ink droplets are ejected from the nozzles 41b, 41c, and 41d disposed to face the pressure chamber C1. Then, the droplets Id are ejected onto the paper P disposed to face the nozzles.

The CPU 16a controls the circulation pump 34 to circulate the fluid in a circulation flow path passing through the ink tank 32 and the ink jet head 31. Through the circulation operation, the ink in the ink tank 32 flows into the common chamber C2 having a flow path portion through a supply hole (not specifically depicted in the drawings), and is supplied to the plurality of pressure chambers C1.

FIG. 7 is an explanatory diagram illustrating the fluid ejection operation of the ink jet head 31, and illustrates a configuration of the nozzle plate 41 and a shape of the landed droplet Id.

FIG. 8 illustrates the fluid ejection operation and the landing shape of droplets from the ink jet head 31 (on an embodiment) and the landing shape of droplets of an ink jet head 531, which is an inkjet head according to a first comparative example, when the paper P travels in the X direction.

FIG. 9 illustrates a fluid ejection operation and the landing shape of droplets from the ink jet head 31 (of an embodiment) and the landing shape of droplets from ink jet head 531, when the paper P is travels in the Y direction. In the first comparative example, cylindrical nozzles 541b, 541c, and 541d have the same shape, and nozzle minimum diameters (at the ejection surface) and thus the throttling dimensions are the same for each nozzle.

In the ejection operation, a distance G (see FIG. 7) between the ejection surface of the nozzles 41b, 41c, and 41d and the paper P is set to 0.5 mm to 5 mm, and preferably, to 2 mm to 3 mm. In addition, transport speed of the paper P is set to 0.4 m/sec in this example.

The distance G between the ejection surface and the paper P is set to 2 mm to 3 mm and the transport speed of the paper P is set to 0.4 m/sec for the fluid ejection operations illustrated in FIGS. 7 to 9.

As illustrated in FIGS. 7 to 9, in the ink jet head 31, the nozzles 41b, 41c, and 41d communicating with the common pressure chamber C1 are formed such that ejection speed is adjusted relative to each other. Therefore, landing timing of the droplet can be adjusted.

In the first comparative examples, as illustrated in FIGS. 8 and 9, the nozzle plate 541 includes the nozzles 541b, 541c, and 541d each having the same shape, and thus the landing timing of droplets from the nozzle 541d (located at the center of the nozzle group) is delayed, and thereby, the landing position is shifted.

For example, as illustrated in FIG. 8, if the paper P moves relative to the ink jet head 531 in the X direction (that is a direction parallel to the alignment direction of the nozzles 541b, 541c, and 541d), the fluid droplet Id from the nozzle 541d at the central portion is located behind the position of the droplets Id from the nozzles 541b and 541c and the landing position is shifted along the movement direction of the paper P.

As illustrated in FIG. 9, in the ink jet head 531, if the paper P moves in the Y direction, the droplet Id from the nozzle 541d at the center portion is located behind the droplets Id from the nozzles 541b and 541c in the movement direction of the paper P and the landing position is again shifted.

In contrast, in the ink jet head 31 according to the present embodiment, the nozzle 41d at the center portion has a smaller in diameter than the nozzles (41b, 41c) at the ends of the nozzle group. As a result, the ejection speed from the nozzle 41d increases, and as a result, the ejection speeds of the nozzles 41b, 41c, and 41d can be made more uniformed. Accordingly, the landing timing of droplets from the nozzle group can be adjusted as compared to the comparative examples, and thereby, the landing positions of droplets from each nozzle in the nozzle group 41 are gathered more closely at desirable places and a more desirable landing shape is obtained as compared to the comparative examples. Among the three nozzles 41b, 41c, and 41d in the ink jet head 31, the pressure of the nozzle 41d at the central portion is higher than pressures of the nozzles 41b and 41c when ejecting the ink. Therefore, the desirable landing shape can be obtained.

The ink jet head 31 according to the first embodiment includes a nozzle plate including a nozzle group 41a including three nozzles 41b, 41c, and 41d communicating with the common pressure chamber C1, and thereby, a large amount of the fluid can be ejected in one ejection drive. That is, in the ink jet head 31 according to the first embodiment, a large amount of fluid can be ejected, and the landing positions are gathered to obtain a desirable landing shape.

The ink tank 32 for storing fluid is connected to the ink jet head 31 according to the first embodiment, and the fluid is circulated through a circulation path that passes through the ink jet head 31 and the fluid tank. That is, in the ink jet head 31 according to the first embodiment, even if the fluid has a high specific gravity or the fluid has a high viscosity, a large amount of fluid can still be ejected, and the landing positions are gathered to obtain a desirable landing shape.

The present disclosure is not limited to the example embodiments described above, and the configuration elements can be modified without departing from the gist of the present disclosure.

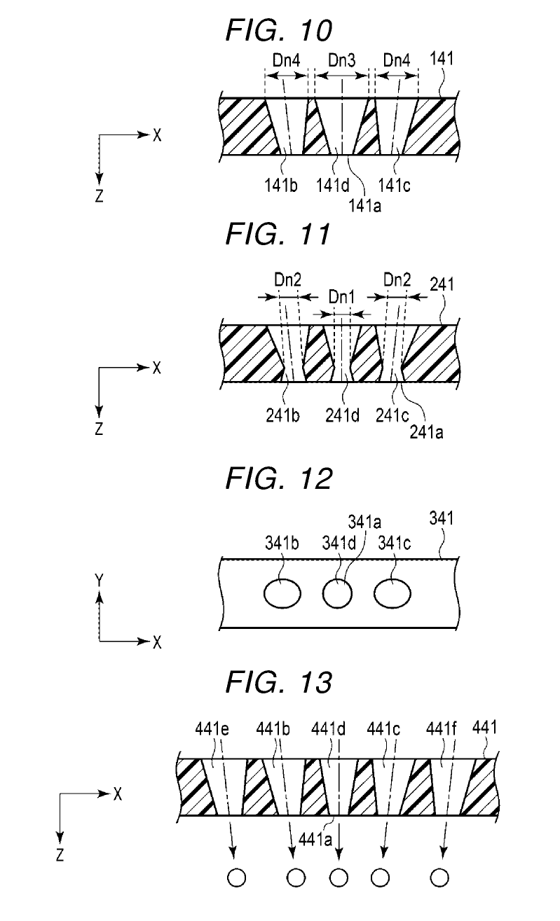

For example, in the first embodiment, nozzle diameters on the ejection surfaces of the nozzles 41b, 41c, and 41d are made different from each other such that different nozzle shapes are provided to adjust the ejection speed from each nozzle, but the present disclosure is not limited to this particular example. For example, as depicted in FIG. 10, the nozzle 141d at the central portion may have greater throttling than the nozzles 141b and 141c. That is, even if an opening area of the nozzles at the ejection surface is the same for each nozzle, a different amount of throttling of the nozzles can be provided to adjust ejection speeds from the respective nozzles by altering a tapering dimension at a point away from the ejection face for each nozzle. For example, in general, a less severe taper angle in the nozzle results in higher the ejection speeds. In the nozzle plate 141, a taper angle of the nozzles 141b, 141c is different from the nozzle 141d, and an opening diameter Dn3 of the nozzle 141d on the base plate 42 side is larger than opening diameters Dn4 of the nozzles 141b and 141c. Also, in this case, since the ejection speeds of the nozzles 141b, 141c, and 141d can be made equal, a desirable landing shape can be obtained by adjusting a landing position of the droplets ejected from each of the nozzles 141b, 141c, and 141d in a similar manner as in the first embodiment. Among the three nozzles 141b, 141c, and 141d, a pressure of the nozzle 141d at the central portion is higher than pressures of the nozzles 141b and 141c at the ends, when ejecting the ink. Therefore, a desirable landing shape is obtained.

In addition, the position at which the nozzle diameters (throttling dimensions) are different from each other is not limited to the ejection surface, but may instead be at an intermediate portion of the nozzle. For example, in a nozzle plate 241 illustrated in FIG. 11, nozzles 241b, 241c, and 241d include throttling portions having their minimum diameters at the midway portions thereof. In this case, the amount of throttling of the nozzle 241d at the central portion is increased relative to the other nozzles. That is, a nozzle diameter, which is an opening diameter of the throttling portion of the nozzle 241d at the central portion, is reduced more than the nozzle diameter of the nozzles 241b and 241c at the end portions. In this context, nozzle diameter (throttling dimension) is a minimum opening diameter of a throttling portion within the respective nozzles. In this example, nozzle diameter Dn1 is less than nozzle diameter Dn2, and thereby, an ejection speed can be made equal among the nozzles 141b, 141c, and 141d. Accordingly, a landing position can be adjusted and a desirable landing shape obtained as in the first embodiment. Among the three nozzles 241b, 241c, and 241d in the nozzle plate 241, a pressure of the nozzle 241d at the central portion is higher than pressures of the nozzles 241b and 241c, when ejecting the ink. Therefore, a desirable landing shape can be obtained.

A shape of an opening of a nozzle is not limited to a circular shape, and other shapes may be used. FIG. 12 is a bottom view of a nozzle plate 341 according to another embodiment. Nozzles 341b and 341c of the nozzle plate 341 are formed in an elliptical shape, and a nozzle 341d is formed in a circular shape. That is, the nozzle 341d disposed at the central portion of a nozzle group 341a includes an opening having a more circular shape than the nozzles 341b and 341c. As an example, the nozzles 341b and 341c have elliptical shapes elongated in the X direction and have a long (major) axis of 33 μm in the X direction and a short (minor) axis of 27 μm in the Y direction. The circular nozzle 341d has a diameter of 27 μm. In this example, a ratio between long axis to the short axis of ellipses of the nozzles 341b and 341c is 11:9.

The nozzle 341d having a circle-like shape has a faster ejection speed than the nozzles 341b, 341c having an elliptical shape, thus the ejection speed of the nozzle 341d can be increased and the ejection speeds of the three nozzles 341b, 341c, and 341d can be made equal by making the nozzle 341d have a shape close to a circle. Therefore, in the same manner as in the first embodiment, a landing position can be adjusted and a desirable landing shape obtained. Among the three nozzles 341b, 341c, and 341d in the nozzle plate 341, a pressure of the nozzle 341d at the central portion is higher than pressures of the nozzles 341b and 341c when ejecting the ink. Therefore, a desirable landing shape is obtained.

In example embodiments described above, the nozzles 341b and 341c have a long elliptical axis along the X direction, and thereby, there are effects in which the nozzles 341b and 341c can be prevented from being too close to an edge portion of a groove, and the amount of flow and the ejection speed can be adjusted efficiently in a narrow space. The major axis of the elliptical shape for the nozzles may be along in the X direction and the minor axis along in Y second direction or vice versa.

The number of nozzles in each nozzle group is not limited to three, and may be four or more. For example, a nozzle plate 441 illustrated in FIG. 13 includes five nozzles 441b, 441c, 441d, 441e, and 441f. In this case, for example, a diameter of the central nozzle 441d is smaller than diameters of the two adjacent nozzles 441c and 441b, and diameters of the nozzles 441e and 441f at the ends of the group are larger than the diameters of the nozzles 441c and 441b, and thereby, the ejection speed can be made equal amongst the plurality of nozzles in the nozzle group. Therefore, in the same manner as in the first embodiment, a landing position can be adjusted and a desirable landing shape obtained. Among the five nozzles 441b, 441c, 441d, 441e, and 441f in the nozzle plate 441, a pressure of the nozzle 441d at the central portion is higher than pressures of the nozzles 441c and 441b on both sides, and pressures of the nozzle 441c and 441b are higher than pressures of the nozzles 441e and 441f at both ends, when ejecting the ink. Therefore, a desirable landing shape can be obtained.

The ink jet recording apparatus 1 according to the example embodiments described above is an ink jet printer which forms a two-dimensional image on an image forming medium S by using ink. However, the ink jet recording apparatus is not limited to this particular example. The ink jet recording apparatus may be, for example, a 3D printer, an industrial manufacturing machine, a medical machine (e.g., a liquid dispensing apparatus), or the like. When the ink jet recording apparatus according to an embodiment is a 3D printer, the ink jet recording apparatus ejects a binder or the like for solidifying a material to become a harden substance for forming a three-dimensional object.

The ejection method is not also limited to the above examples. For example, other methods such as a bubble method and a Kaiser method, which uses piezoelectric elements, can also be applied.

The ink jet recording apparatus 1 according to the example embodiments described above includes four ink jet heads 31, and colors of ink used by each ink jet head 31 are cyan, magenta, yellow, and black. However, the number of ink jet heads 31 included in the ink jet recording apparatus is not limited to four, and may be any number. The colors and characteristics of the ink used by each ink jet head 31 are not limited. An ink jet head 31 can also eject transparent gloss ink, ink that develops color when irradiated with infrared rays or ultraviolet rays, or other special inks. Furthermore, the ink jet heads 31 may be able to eject fluids other than the ink. The fluid ejected by the ink jet head 31 may be dispersion fluid such as suspension. Fluid other than the ink ejected by the ink jet head 31 includes fluid such as a resist material for forming a wiring pattern of a printed wiring board, a fluid including a cell for artificially forming a tissue or an organ, binder such as adhesive, wax, a fluid resin precursor, and the like.

While certain embodiments have been described, these embodiments have been presented by way of example only, and are not intended to limit the scope of the present disclosure. Indeed, the novel embodiments described herein may be embodied in a variety of other forms. Furthermore, various omissions, substitutions and changes in the form of the embodiments described herein may be made without departing from the spirit of the inventions. The accompanying claims and their equivalents are intended to cover such forms or modifications as would fall within the scope and spirit of the disclosure.

What is claimed is:

1. A fluid ejection head, comprising:
a pressure chamber; and
a nozzle plate including a nozzle group, the nozzle plate having a discharge face with an upstream side and a downstream side, the nozzle group being in fluid communication with the pressure chamber and including:
a first nozzle on the upstream side of the discharge face,
a second nozzle on the downstream side of the discharge face, and
a third nozzle between the first and second nozzles, wherein
central axes of the first and second nozzles are inclined with respect to a central axis of the third nozzle such that the central axes of the first and second nozzles intersect the central axis of the third nozzle, and
a flow channel dimension of the third nozzle is different from flow channel dimensions of the first and second nozzles.

2. The fluid ejection head according to claim 1, wherein the first and second nozzles each have minimum flow channel dimensions which are less than a minimum flow channel dimension of the third nozzle.

3. The fluid ejection head according to claim 1, wherein the flow channel dimensions of each of the first, second, and third nozzles are tapered along the central axis thereof, the flow channel dimension of each nozzle being smallest equal the discharge face, the flow channel dimension of the third nozzle adjacent to the pressure chamber being greater than the flow channel dimension of the first and second nozzles adjacent to the pressure chamber.

4. The fluid ejection head according to claim 1, wherein the first, second, and third nozzles each have a circular opening at the discharge face.

5. The fluid ejection head according to claim 1, wherein the first and second nozzles each have an elliptical opening at the discharge face.

6. The fluid ejection head according to claim 5, wherein a major axis of the first and second nozzles is parallel to a direction from the upstream side to the downstream side of the discharge face.

7. The fluid ejection head according to claim 1, the nozzle group further comprising:
a fourth nozzle between the first nozzle and the third nozzle; and
a fifth nozzle between the second nozzle and the third nozzle, wherein
a minimum flow channel dimension of the fourth nozzle is between the minimum flow channel dimension of the third nozzle and the flow channel minimum dimension of the first nozzle, and
a minimum flow channel dimension of the fifth nozzle is between the minimum flow channel dimension of the third nozzle and the minimum flow channel dimension of the second nozzle.

8. The fluid ejection head according to claim 1, wherein
the first, second, and third nozzles are aligned in a first direction,
a supply flow path for supplying fluid to the pressure chamber is connected to a portion of the nozzle plate closer to the first nozzle along the first direction, and
a recovery flow path for recovering fluid from the pressure chamber is connected to a portion of the nozzle plate closer to the second nozzle along the first direction.

9. A fluid ejection head, comprising:
a pressure chamber; and
a nozzle plate including a nozzle group including at least three nozzles, the nozzle plate having a discharge face with an upstream side and a downstream side, the nozzle group being in fluid communication with the pressure chamber and including:
a first nozzle on the upstream side of the discharge face,
a second nozzle on the downstream side of the discharge face, and
a third nozzle between the first and second nozzles, wherein
central axes of the first and second nozzles are inclined with respect to a central axis of the third nozzle such that the central axes of the first and second nozzles intersect the central axis of the third nozzle on a fluid ejection side of the nozzle plate, and
the third nozzle has a throttle dimension which is different from a throttle dimension of the first nozzle and a throttle dimension of the second nozzle, and the respective throttle dimensions being set such that a liquid ejection speed from each of the first, second, and third nozzles is substantially equal.

10. The fluid ejection head according to claim 9, wherein the first and second nozzles each have minimum flow channel dimensions which are less than a minimum flow channel dimension of the third nozzle.

11. The fluid ejection head according to claim 9, wherein the flow channel dimensions of each of the first, second, and third nozzles are tapered along the central axis thereof, the flow channel dimension of each nozzle being smallest equal the discharge face, the flow channel dimension of the third nozzle adjacent to the pressure chamber being greater than the flow channel dimension of the first and second nozzles adjacent to the pressure chamber.

12. The fluid ejection head according to claim 9, wherein the first, second, and third nozzles each have a circular opening at the discharge face.

13. The fluid ejection head according to claim 9, wherein the first and second nozzles each have an elliptical opening at the discharge face.

14. The fluid ejection head according to claim 13, wherein a major axis of the first and second nozzles is parallel to a direction from the upstream side to the downstream side of the discharge face.

15. The fluid ejection head according to claim 9, the nozzle group further comprising:
a fourth nozzle between the first nozzle and the third nozzle; and
a fifth nozzle between the second nozzle and the third nozzle, wherein
a throttle dimension of the fourth nozzle is between the throttle dimension of the third nozzle and the throttle dimension of the first nozzle, and
a throttle dimension of the fifth nozzle is between the throttle dimension of the third nozzle and the throttle dimension of the second nozzle.

16. The fluid ejection head according to claim 9, wherein
the first, second, and third nozzles are aligned in a first direction,
a supply flow path for supplying fluid to the pressure chamber is connected to a portion of the nozzle plate closer to the first nozzle along the first direction, and
a recovery flow path for recovering fluid from the pressure chamber is connected to a portion of the nozzle plate closer to the second nozzle along the first direction.

17. A fluid ejection apparatus, comprising:
a transport apparatus configured to transport an ejection target along a transport path; and
a fluid ejection configured to eject a fluid towards the ejection target on the transport path, the fluid head comprising:
a pressure chamber; and
a nozzle plate including a nozzle group, the nozzle plate having a discharge face with an upstream side and a downstream side, the nozzle group being in fluid communication with the pressure chamber and including:
a first nozzle on the upstream side of the discharge face,
a second nozzle on the downstream side of the discharge face, and
a third nozzle between the first and second nozzles, wherein
central axes of the first and second nozzles are inclined with respect to a central axis of the third nozzle such that the central axes of the first and second nozzles intersect the central axis of the third nozzle, and
a flow channel dimension of the third nozzle is different from flow channel dimensions of the first and second nozzles.

18. The fluid ejection apparatus according to claim 17, wherein the first and second nozzles each have minimum flow channel dimensions which are less than a minimum flow channel dimension of the third nozzle.

19. The fluid ejection apparatus according to claim 17, wherein the flow channel dimensions of each of the first, second, and third nozzles are tapered along the central axis thereof, the flow channel dimension of each nozzle being smallest equal the discharge face, the flow channel dimension of the third nozzle adjacent to the pressure chamber being greater than the flow channel dimension of the first and second nozzles adjacent to the pressure chamber.

20. The fluid ejection apparatus according to claim 17,
wherein when a distance between the nozzle plate is a value Pt, a distance between the nozzle plate and the ejection target on the transport apparatus is a value G, and an angle between the central axis of one of the first or second nozzles and the central axis of the third nozzle at the central portion is a value θ, the relationship of 2×P/G>tan θ>0 is satisfied.
